(19) United States
(12) Patent Application Publication
(10) Pub. No.: US 2004/0065606 A1
(43) Pub. Date: Apr. 8, 2004

(54) Assembly comprising a permeable medium and a frame

(76) Inventors: Geert Devooght, Koekelare (BE); Johan Vanderstraeten, Gavere (BE)

Correspondence Address: FOLEY AND LARDNER, SUITE 500, 3000 K STREET NW, WASHINGTON, DC, 20007, US

(21) Appl. No.: 10/466,173

(22) PCT Filed: Jan. 10, 2002
(86) PCT No.: PCT/EP02/00440

(30) Foreign Application Priority Data
Jan. 18, 2001 (EP) 01200185.5

(51) Int. Cl. B01D 27/00

(52) U.S. Cl. 210/483; 29/896.62

(57) ABSTRACT

An assembly comprising a permeable medium and a frame is provided. The permeable medium comprises a sintered fleece comprising metal fibers. A leak-proof seal between the permeable medium and the frame is assured by spraying a ceramic or metallic layer onto the junction permeable medium/frame. The assembly is in particular suitable to be used as filter element.

### FIELD OF THE INVENTION

The present invention relates to an assembly comprising a permeable medium and a frame; the permeable medium and the frame are secured and sealed to each other in a leak-proof way.

More in particular, the invention relates to a filter element.

The invention further relates to a method for sealing a permeable medium to a frame.

### BACKGROUND OF THE INVENTION

In the manufacturing of filter elements, the way of securing and sealing a filter medium to a medium holder or frame is a difficult and critical step. More particularly, the construction of filter elements comprising pleated filter media presents problems to bond the periphery of the filter medium to the frame.

In order to obtain a useful and reliable filter element, a number of requirements have to be met.

First of all, it is essential that a strong, leak-proof seal is created at the filter medium/filter frame junction.

Even the smallest leakages at the junction result in a malfunction of the filter.

In case of pleated filter media, the pleat openings have to be closed and sealed in order to guide the gas or liquid via an inlet pleat opening, through the filter medium to the outlet pleat opening, at the other side of the filter medium.

Another requirement is that the filter element and more particularly the junction filter medium/frame has to withstand high temperatures and/or high temperature variations.

A number of techniques for sealing a filter medium to a frame are currrently known in the art. Known methods are for example gluing, welding or rolling.

However, these filter elements show the drawback that they do not withstand high temperatures and high pressures to a sufficiently high degree. The connection and sealing between the filter medium and the frame is easily broken due to thermal shocks because of the different thermal coefficients of expansion of parts being connected to each other. Particularly, the parts that has to withstand deformations, for example at the seal, are easily broken.

Variations in the pressure increase the aging effects especially at such deformed places.

A further drawback of the filters known in the art is that the seal between the filter medium and the frame is often not leak-proof.

### SUMMARY OF THE INVENTION

It is an object of the present invention to provide an assembly comprising a permeable medium and a frame avoiding the problems of the prior art.

It is another problem to provide an assembly whereby the permeable medium is sealed to the frame in a fluid-tight way.

It is also an object to provide an assembly comprising a permeable medium and a frame, characterised by a strong seal between the permeable medium and the frame, which can withstand high temperatures and high temperature variations and/or high pressures and high pressure variations.

Another object is to use the assembly according to the present invention as a filter element.

It is a further object to provide a method to seal a permeable medium to a frame in a fluid-tight way.

According to a first aspect of the present invention an assembly comprising a permeable medium and a frame is provided. The permeable medium is secured by said frame and is then sealed to the frame by means of a sprayed ceramic or metallic layer. The ceramic or metallic layer is sprayed onto the junction permeable medium/frame.

With junction permeable medium/frame is meant the area where the permeable medium and the frame touch each other.

With frame is meant any structure that holds the permeable medium. The frame may give a rigid support to the permeable medium.

The sprayed metal or ceramic layer ensures that the permeable medium is sealed to the frame in a fluid-tight way.

In case the assemby concerns a filter element, the sprayed metal or ceramic layer ensures that the filter rating of the filter medium as such is maintained after mounting the medium in a frame.

The permeable medium comprises preferably a sintered fleece comprising metal fibers. This fleece comprises at least one non woven web of metal fibers, preferably stainless steel fibers.

The metal fibers have preferably a diameter ranging between 1 μm and 100 μm. More preferably, the diameter of the metal fibers is between 1 and 35 μm, for example 2 μm, 4 μm, 8 μm or 12 μm.

The metal fibers may be obtained by any technique known in the art. They are for example obtained by bundle drawing or shaving.

The permeable medium can be a layered structure comprising a number of different layers one on top of the other; each layer comprising a sintered metal fiber fleece. The permeable medium is for example a multilayered structure comprising a first layer comprising metal fibers with a diameter between 4 and 10 μm and a second layer comprising metal fibers with a diameter between 2 and 4 μm.

The choice of the permeable medium is dependent upon the application. In case of filter elements, the choice of the filter medium is dependent upon the required filter characteristics such as pore size, filter rating, porosity, etc.

It is desired that the permeable medium can withstand a sufficient high temperature, i.e. that it can withstand the temperature reached during the spraying operation.

The alloy of the metal fibers is to be chosen in order to resist the working circumstances to which the final product is subjected.

Stainless steel fibers out of AISI 300-type alloys, e.g. AISI 316L are preferred in case temperatures up to 360° C. are to be resisted. Fibers based on INCONEL®-type alloys such as INCONEL®601 or HASTELLOY®-type alloys such as HASTELLOY® HR may be used up to 500° C., respectively 560° C. Fibers based on Fe—Cr—Al alloys may be chosen to resist temperatures up to 1000° C. or even more.

The permeable medium may further comprise metal particles, such as metal powder or short metal fibers.

The permeable medium may have any shape. It may for example be flat or cylindrical.

The permeable medium may also be pleated. Different pleating geometries are thereby possible.

For example, a permeable medium can be pleated providing pleats of which the pleating lines run substantially parallel to each other.

Another geometry concerns a cylindrical permeable medium pleated in such a way that the pleating lines are running parallel to the central axis.

As described above, the function of the frame is to hold the permeable medium and/or to give a rigid support to the permeable medium.

A further function of the frame can be to close the pleat opening of the permeable medium in order to prevent undesired by-passes; for example to prevent the flow of gas or liquid from the inlet of the filter to the outlet of the filter without passing through the permeable medium.

The frame may comprise one or more external walls, such as an inner and an outer wall, or it may comprise a wall comprising more than one part, for example an upper and a lower part.

Alternatively, the frame may comprise one or more caps.

The frame can for example be made of a metallic, a ceramic or o polymeric material.

In case the assembly is to be used for high temperature applications, the frame is preferably made of a metal or a metal alloy, for example steel.

In a preferred embodiment the filter element comprises a frame comprising an upper and a lower part.

In case of a pleated medium, such as a pleated filter medium, the edge of the upper part coming into contact with the pleated filter medium has a waved shape, identical to the waved shape of the outer edge of the filter medium due to the pleating. The edge of the lower part, coming into contact with the pleated sintered metal fiber fleece has also a waved shape, identical to the waved shape of the edge of the pleat openings due to the pleating.

The pleated filter medium is then placed and squeezed between the upper and the lower part of the frame, in such a way that the pleat openings are closed by the waves on the edges of the two parts.

The upper part of the frame, the pleated filter medium and the lower part of the frame are connected to each other by spraying a layer of ceramic or metallic material on the filter medium/frame junction.

In an alternative embodiment, the permeable medium is secured by means of filter caps.

This is for example advantageous in case of a filter tube. Such a filter tube can have end caps, either at its upper side, at its lower side or both at its upper and lower side. The filter caps secure the filter medium and they facilitate the mounting of the filter tube in a more complex filter structure.

In case the assembly is intended to be used at high temperatures, the frame is preferably made out of metal, for example steel. More preferably, the frame is made of stainless steel.

The permeable medium is secured and sealed to the frame by spraying a ceramic or metallic layer onto the junction permeable medium/frame. A preferred technique is thermal spraying. Different spraying techniques can be considered such as flame spraying or spraying using an electric arc or plasma gun.

A sprayed metal layer may comprise any metal or metal alloy. Preferred metal layers comprise steel, stainless steel, zinc alloys or nickel alloys.

A sprayed ceramic layer may comprise for example metal oxides (for example sodium oxide, potassium oxide, aluminium oxide, zirconium oxide, titanium oxide), carbides (for example tungsten carbide), silicates (for example sodium silicate, potassium silicate, zirconia silicate), nitrides (for example boron nitride) or may comprise mixtures thereof.

The thickness of the sprayed layer is preferably between 1 and 5000 μm, preferably between 1 and 1000 μm.

The sprayed layer forms an equal and intimate contact with the junction permeable medium/frame, assuring a leak-proof seal between the permeable medium and the frame.

The seal between the permeable medium and the frame is more reliable and is less sensitive to temperature variations than in case the medium is secured and sealed to the frame by means of a glue or by welding.

In a preferred embodiment the sprayed material is the same as the material of the permeable medium and/or of the filter frame. This is in particular advantageous for filter elements which have to be used at high temperatures or which have to withstand high temperatures variations.

According to a second aspect a method of manufacturing an assembly according to the invention is provided.

The method comprises the steps of

providing a permeable medium;

providing a frame;

securing the permeable medium to the frame;

spraying a metallic or ceramic layer onto the junction permeable medium/frame.

The spraying is preferably thermal spraying such as flame spraying or spraying using an electric arc or plasma gun.

The assembly as subject of the present invention can be used for all kind of applications whereby a permeable medium has to be fixed to a frame. The assembly is more particularly interesting for all applications whereby a leak-proof connection between the permeable medium and the frame is desired.

Assemblies according to the present invention can be used for the filtration of all kind of gases and liquids, such as the filtration of water, waste water, oil, beverages, . . . .

Since the assemblies according to the present invention can withstand high temperatures and high temperature variations they are very suitable to filtrate hot gases. They are suitable to be used to filter exhaust gases for example of combustion engines.

Another application of the assemblies according to the invention is the use as carrying element for catalyst, e.g. in the exhaust system of combustion engines.

Furthermore, an assembly according to the present invention can be used as diffuser, for example as aeration diffuser.

### BRIEF DESCRIPTION OF THE DRAWINGS

The invention will now be described into more detail with reference to the accompanying drawings wherein

FIG. 1 shows an assembly comprising a flat permeable medium and a frame surrounding this permeable medium;

FIG. 2 shows a cylindrical permeable medium, held by two filter caps;

FIG. 3 shows a top view of a pleated medium;

FIG. 4 shows two parts of a filter frame, squeezing a filter medium as shown in FIG. 3;

FIG. 5 shows a filter element according to the present invention on which a layer is sprayed at the filter medium/frame junction;

FIG. 6 and 7 show an alternative embodiment of a pleated filter medium;

FIG. 8 shows a pleated permeable medium, held by two filter caps.

### DESCRIPTION OF THE PREFERRED EMBODIMENTS OF THE INVENTION

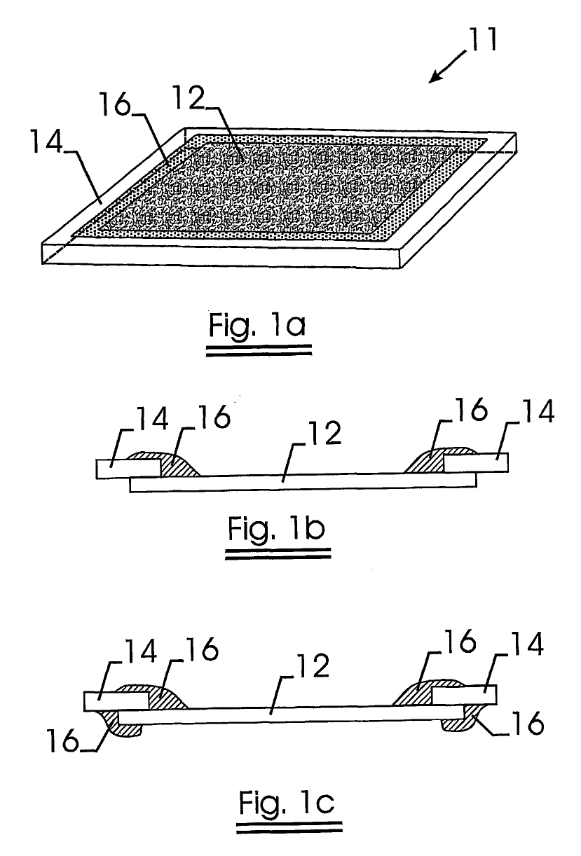

A preferred embodiment of an assembly according to the present invention is shown in FIG. 1.

The assembly comprises a permeable medium 12 and a frame, surrounding the permeable medium. The permeable medium comprises a web of metal fibers which has been sintered.

The assembly is used as a filter element.

Upon the junction permeable medium/frame a metallic layer 16, more particularly a stainless steel layer, is sprayed either at the upper surface of the junction filter medium/filter frame (as shown in FIG. 1b) or both at the upper and lower surface of the junction filter medium/filter frame (as shown in FIG. 1c).

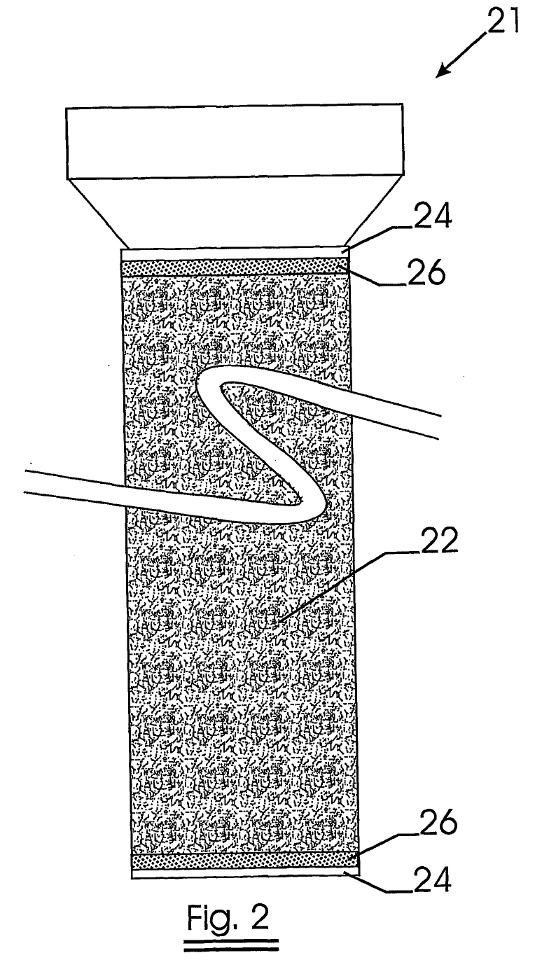

FIG. 2 shows an alternative embodiment of an assembly 21 according to the present invention.

The permeable medium 22 comprises a cylindrical filter medium. The cylindrical medium is secured by two filter caps 24. These filter caps also have as function to facilitate the mounting of the filter element in a more complex filter structure.

Upon the junctions filter medium/filter caps a layer of aluminium oxide 26 is sprayed.

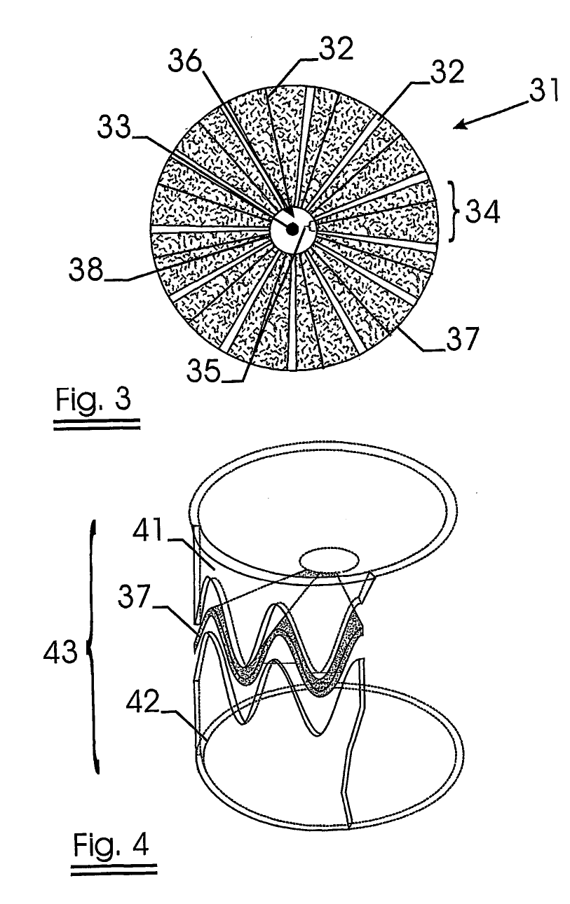

A preferred embodiment of a filter element as subject of the invention is shown in FIG. 3. The filter medium comprises a pleated sintered metal fiber fleece 31.

The sintered metal fiber fleece 31 is pleated as shown in FIG. 3 in such a way that the pleating lines 32 extend from a central axis 33 outwards. Each pleat so comprises one pleat opening 34 extending outwards, where a second pleat opening 35 extends toward this central axis 33 in an open core area 36. All pleat openings extending outwards provide a waved edge 37. All pleat openings extending towards the open core area provide a waved edge 38.

As shown in FIG. 4, the outer edge 37 of the pleated sintered metal fiber fleece is positioned and squeezed between an upper part 41 and a lower part 42 of the frame 43. The upper and the lower part have a waved shape at the lower and upper side respectively; the waved shape corresponds with the outer edge 37 of the pleated sintered metal fiber fleece. Upper part 41 and lower part 42 are pressed to each other with the pleated sintered metal fiber fleece inbetween.

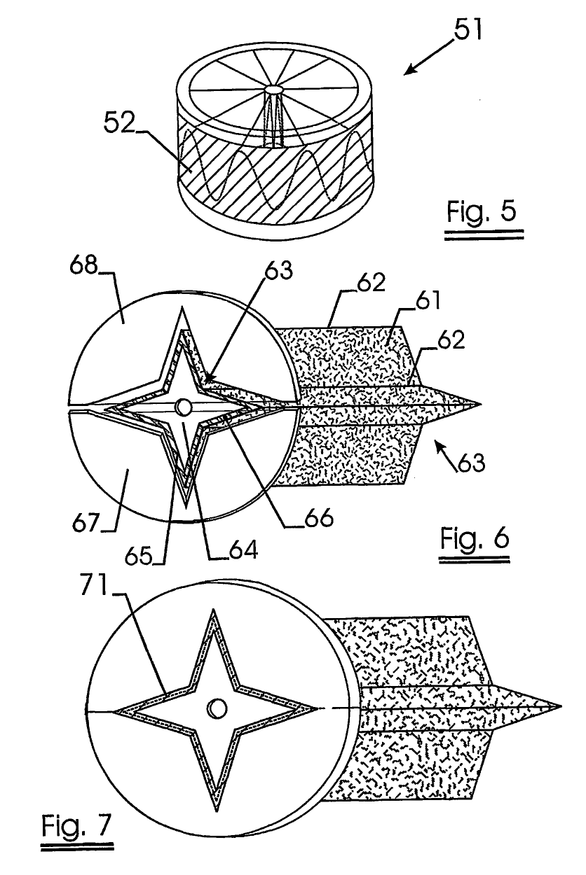

FIG. 5 shows a filter element 51 according to the present invention, comprising a filter medium and frame as in FIG. 4.

The two parts of the frame and the filter medium are permanently connected and sealed to each other by spraying an inox metal layer 52 onto the junction filter medium/frame parts.

This spraying is preferably done at the outer side of the outer wall.

Pleat openings extending towards the central axis can be closed in a similar way.

Another embodiment is shown in FIG. 6 and FIG. 7, where a sintered metal fiber fleece 61 is pleated in a cylindrical way, comprising pleating lines 62 which are essentially parallel to each other.

The pleat openings 63, at each side of the cylinder shape, are to be closed by two external walls, one at each side of the cylinder. This can be done by inserting a lower part 64 of the external wall at the inner part of the pleated sintered metal fiber fleece, in order to allow the edge 65 of this lower part to fit with the waved shape 66 of the pleated sintered metal fiber fleece 61. A second and third upper part of the external wall 67 and 68, each having an edge which fit with a part, e.g. half of the circumference of the pleated sintered metal fiber fleece 61 are used to position and squeeze the pleated sintered metal fiber fleece between the three parts of the external wall.

A metal layer 71 is sprayed on the junction filter medium/frame.

The pleat openings, at the other side, may be closed by an other external wall in similar way.

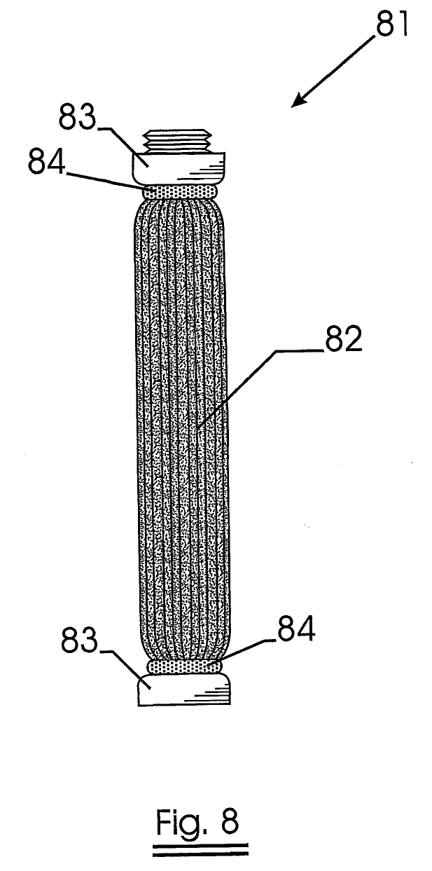

FIG. 8 shows a tubular filter element 81 comprising a pleated filter medium 82 secured by to end caps 83.

A layer 84 comprising stainless steel is sprayed at the junction permeable medium/frame

1. An assembly comprising a permeable medium and a frame, said permeable medium being secured by said frame, said permeable medium being a sintered fleece comprising metal fibers, said permeable medium being sealed to said frame by means of a sprayed ceramic or metallic layer; said sprayed ceramic or metallic layer being applied onto the junction permeable medium/frame.

2. An assembly according to claim 1, whereby said sprayed ceramic or metallic layer forms a leak-proof seal between said permeable medium and said frame.

3. An assembly according to claim 1 or 2, whereby said metal fibers have a diameter ranging between 1 and 100 μm.

4. An assembly according to any one of the preceding claims, whereby said sprayed ceramic or metallic layer is applied onto the junction permeable medium/frame by thermal spraying.

5. An assembly according to any one of the preceding claims, whereby said sprayed metallic layer comprises a metal or metal alloy.

6. An assembly according to any one of the preceding claims, whereby said sprayed ceramic layer comprises a ceramic material selected from the group consisting of metal oxides, carbides, silicates, nitrides and mixtures thereof.

7. An assembly according to any one of the preceding claims, whereby said permeable medium is a flat or cylindrical medium.

8. An assembly according to any one of the preceding claims, whereby said permeable medium is pleated.

9. An assembly according to any one of the preceding claims, whereby said frame is made of a metallic, ceramic or polymeric material.

10. An assembly according to any one of the preceding claims, whereby said frame comprises at least one external wall.

11. An assembly according to any one of the preceding claims, whereby said wall comprises an upper and a lower part.

12. An assembly according to any one of the preceding claims, whereby said frame comprises at least one filter cap.

13. An assembly according to any one of the preceding claims, whereby said permeable medium is a filter medium.

14. A method of manufacturing an assembly according to any one of claims 1 to 13, said method comprising the steps of
providing a permeable medium;
providing a frame;
securing the permeable medium to the frame;
spraying a metallic or ceramic layer onto the junction permeable medium/frame.

15. A method according to claim 14, whereby said spraying is thermal spraying.

16. Use of an assembly according to any one of claims 1 to 13, for the filtration of gases or liquids.

17. Use of an assembly according to claim 16, for the filtration of high temperature gases or liquids.

18. Use of an assembly according to claims 16 or 17, for the filtration of exhaust gases.
